(19) United States
(12) Patent Application Publication
(10) Pub. No.: US 2008/0203824 A1
(43) Pub. Date: Aug. 28, 2008

(54) Information processing system and supply device

(75) Inventor: Fumio Koyama, Hara (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/072,219

(22) Filed: Feb. 25, 2008

(30) Foreign Application Priority Data
Feb. 26, 2007 (JP) 2007-045084
Dec. 14, 2007 (JP) 2007-323045

(51) Int. Cl. H01F 38/14; H01F 27/42

(52) U.S. Cl. 307/104

(57) ABSTRACT

There is disclosed an information processing system including: a first device including a magnetic core having a first end part to be brought into close proximity to the second device, and a second end part provided facing the first end part, an exciting coil wound around the magnetic core, and a controller that causes the exciting coil to generate an electric current corresponding to at least one of electric power and information; and a second device including a coil to be excited that generates an electric current in accordance with a variation in magnetic flux, and a processing unit that executes processing by using, as the at least one of the electric power and electronic information, the electric current generated in the coil to be excited, wherein if the controller causes the exciting coil to generate an electric current, the coil to be excited is caused to generate the electric current in accordance with the variation in magnetic flux generated by the electric current generated in the exciting coil.

The entire disclosures of Japanese Patent Application No. 2007-323045 filed on Dec. 14, 2007 and Japanese Patent Application No. 2007-045084 filed on Feb. 26, 2007 are expressly incorporated, by reference thereto, herein.

### BACKGROUND

1. Technical Field

The present invention relates to a technique for supplying electric power and information to a processing device such as electronic paper.

2. Related Art

There are known display devices which are collectively referred to as electronic paper (for example, see JP-A-2005-181436 and JP-A-2006-277261). It is required that such display medium be portable and also be rewritable as readily as sheets of paper. A display device which consumes a relatively low amount of electric power is more useful in view of portability. If only a low power consumption is required, batteries can be made more compact, and charging can be carried out via an external non-contact power supply. Known techniques for providing a non-contact power supply include, for example, those utilizing electromagnetic induction or electromagnetic coupling, and are commonly employed in passive IC cards and IC tags.

However, a display device which displays rewritable information consumes a relatively large amount of electric power. For example, such a display media consumes a higher amount of electric power than an IC card or IC tag. If such a display media is supplied with electric power in the same manner as an IC card or IC tag, it is not possible to supply sufficient electric power in a constant and reliable manner.

### SUMMARY

The present invention has been made in view of the circumstances described above and is directed to achieve efficiency in receiving electric power from a device or in communication of electronic information with the device.

According to one aspect of the invention, there is provided an information processing system including: a first device including a magnetic core having a first end part which is brought into close proximity to the second device, and a second end part provided in opposing relation to the first end part, an exciting coil wound around the magnetic core, and a controller that causes the exciting coil to generate an electric current corresponding to at least one of electric power and electronic information; and a second device including a coil to be excited that generates an electric current in accordance with a variation in magnetic flux, and a processing unit that executes processing by using, as the at least one of the electric power and electronic information, the electric current generated in the coil to be excited, wherein if the controller causes the exciting coil to generate an electric current, the coil to be excited is caused to generate the electric current in accordance with a variation in magnetic flux generated by the electric current generated in the exciting coil. According to the information processing system configured as described above, electric power or electronic information can be efficiently supplied to the second device. In the system, the magnetic core having the first end part which is brought into close proximity to the coil to be excited of the second device. The magnetic core may be provided at the top end of the instruction device, which is, for example, a pen-type pointing device. The magnetic core can have the function of pointing a place as a user likes and the function of enhancing electromagnetic coupling between the coil of the first device and the coil to be excited of the second device. Preferably, a diameter of the magnetic core decreases toward the top of the first end part. In this case, since magnetic flux can be concentrated at the top end of the magnetic core, electric power and electronic information can be effectively supplied to the second device.

The information processing system described above can be alternatively configured so that the coil to be excited of the second device has a first face in a side in which the coil to be excited is brought into close proximity to the first end part of the magnetic core, and a second face facing the first face, and the second device further includes a magnetically highly-permeable member facing the second face of the coil to be excited, the magnetically highly-permeable member containing a magnetic material for causing magnetic lines of force to extend from the first end part toward the magnetically highly-permeable member. By using this configuration, magnetic flux penetrating inside the coil to be excited can be controlled effectively.

Preferably, in a configuration in which the second device is provided with a plurality of coils to be excited, the magnetically highly-permeable member is provided in an opposing relation to the second face of each of the plurality of the coils to be excited. By using this configuration manufacture is facilitated as compared to a case in which there is provided a plurality of coils to be excited with separate magnetically highly-permeable members.

The information processing system described above can also be configured so that the second device is provided with a plurality of coils to be excited, and the second device further includes a determination unit that determines which of the plurality of coils to be excited is brought into close proximity to the first end part of the magnetic core. By using this configuration, each of the coils to be excited can be caused to function as an operation means.

The information processing system described above can also be configured so that the second device further includes a display that displays an image by using an electronic non-volatile display, and the processing unit controls a displayed image by using the at least one of the electric power and electronic information. The non-volatile display requires electric power only when performing a rewriting operation; and it does not require electric power to be supplied to maintain a display state. The non-volatile display is therefore a display means suitable for the invention having the configuration as described above. However, the display means is not limited to that described above and can include any appropriate display as desired.

In the configuration in which the second device is provided with a plurality of coils to be excited, each of the plurality of coils to be excited can be configured to have a first face in a side in which each of the coils to be excited is brought into close proximity to the first end part of the magnetic core, and a second face facing the first face; at least one of the plurality of the coils to be excited can be provided so that the first face is positioned facing a display screen of the display, and below the display screen; and a sheet-like magnetically highly-permeable member covering the display screen is provided facing the second face of the coil to be excited. By this configuration, when the magnetically highly-permeable member generates heat due to loss of magnetic permeability degradation in image quality of the display means which would otherwise occur due to a variation in temperature can be prevented.

According to another aspect of the invention, there is provided a primary coil capable of electromagnetically coupling with a secondary coil by an electric current generated in the primary coil, the coil including: a magnetic core having a first end part in a side in which the primary coil is brought into close proximity to the secondary coil, and a second end part provided in opposing relation to the first end part; and an exciting coil wound around the magnetic core. In the primary coil configured as described above, magnetic flux can be concentrated at the top end of the magnetic core. Accordingly, electric power or electronic information can be efficiently supplied to the secondary coil.

The primary coil as described above can be alternatively configured so that the magnetic core has a protruding part at the second end part, the protruding part protruding in a direction perpendicular to a center axis of the magnetic core. Also alternatively, the magnetic core can have a protruding part at the second end part; the protruding part protruding in a direction perpendicular to a center axis of the magnetic core and having a top end folded back toward the first end part. By using this configuration proper control of magnetic flux is facilitated.

The primary coil as described above can alternatively be configured so as to further include a cover unit that covers a part or all of the magnetic core and the exciting coil. By using this configuration, damage to a device provided with the secondary coil can be prevented.

The invention can also be specified as a supply device which has a primary coil as described above and supplies electric power or electronic information. According to still another aspect of the invention, there is provided a supply device that supplies an external device with at least one of electric power and electronic information by electromagnetic coupling, the supply device including: a magnetic core having a first end part in a side in which the external device is brought into close proximity to the supply device, and a second end part in an opposing relation to the first end part; an exciting coil wound around the magnetic core; and a controller that causes the exciting coil to generate an electric current corresponding to at least one of the electric power and electronic information.

### BRIEF DESCRIPTION OF THE DRAWINGS

An exemplary embodiment of the invention will now be described in detail based on the following drawings wherein:

FIG. 1 schematically shows an information display system according to an exemplary embodiment of the invention;

FIG. 2 is a block diagram showing the entire structure of the information display system;

FIG. 3 is a cross-sectional view showing a structure of a primary coil unit;

FIG. 4 shows a display screen side of a display device;

FIG. 5 is a cross-sectional view of the display device;

FIG. 6 schematically shows how the primary coil unit and a spiral coil are coupled; and

FIGS. 7 and 8 are each cross-sectional views showing different shapes of a magnetic core and peripheral parts.

### DESCRIPTION OF EXEMPLARY EMBODIMENTS

An exemplary embodiment of the present invention will now be described with reference to the drawings.

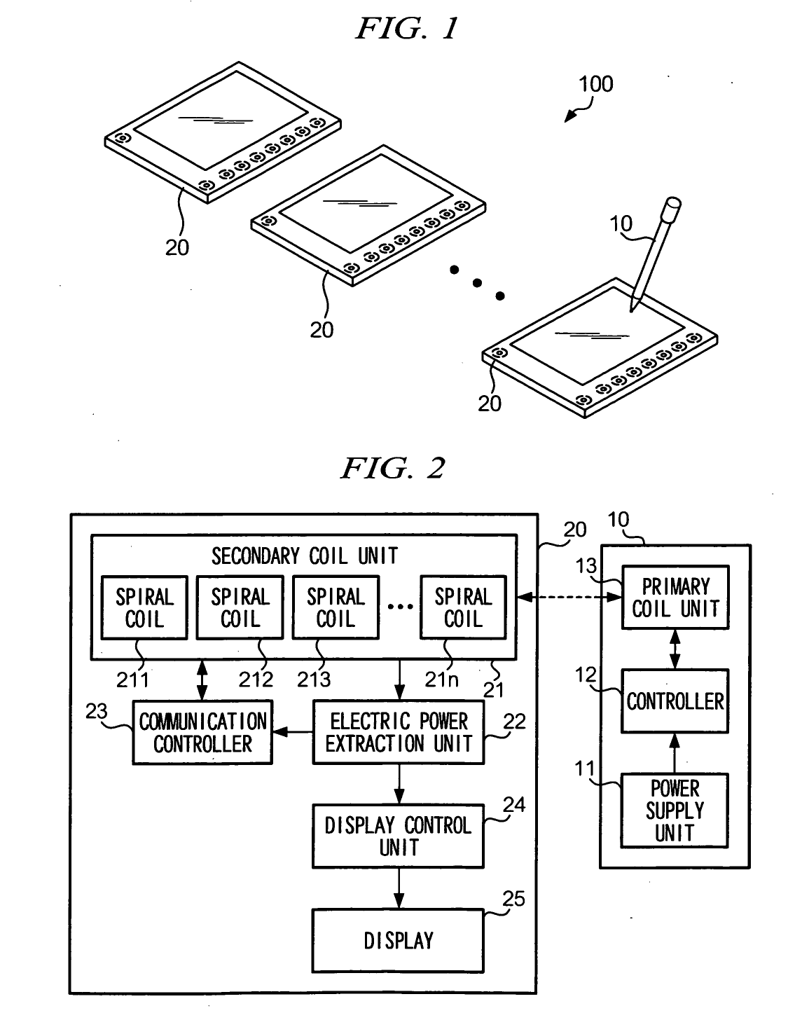

FIG. 1 schematically shows an information display system according to an exemplary embodiment of the invention. As shown in the figure, an information display system 100 according to the embodiment has an instruction device 10 and plural display devices 20. The instruction device 10 is a pen-type processing device which supplies the plural display devices 20 with various instructions related to display operations and supplies electric power for operating the display devices 20. Each of the display devices 20 functions as so-called electronic paper, and performs display operations in accordance with instructions supplied from the instruction device 10. In this embodiment, the instruction device 10 and display devices 20 communicate with each other according to an electronic coupling method using a predetermined frequency band.

In this information display system 100, processing is mainly carried out by the instruction device 10. The display devices 20 operate in accordance with processing results provided by the instruction device 10. From a viewpoint of transmission/reception of electric power or electronic information, the instruction device 10 can be regarded as a host device (a primary device), and the display devices 20 can be regarded as client devices (secondary devices).

FIG. 2 is a block diagram showing an entire structure of the information display system 100. The display devices 20 have a common structure, and for the sake of brevity reiterative descriptions of such common structures will be omitted from the following description. As shown in the figure, the instruction device 10 includes a power supply unit 11, a controller 12, and a primary coil unit 13. The display device 20 includes a secondary coil unit 21, a power extraction unit 22, a communication controller 23, a display controller 24, and a display 25.

The power supply unit 11 supplies electric power for operating the instruction device 10 and display devices 20. The power supply unit 11 has a battery as a power supply source, e.g., a dry cell battery or storage battery. The controller 12 includes a CPU (Central Processing Unit) and a memory, and controls operation of the instruction device 10. The controller 12 controls operation of the primary coil unit 13 by supplying a predetermined electric current. The controller 12 is further capable of generating or storing information including display data, and of supplying the information to the display devices 20. The display data refers to information indicating characters and images to be displayed by the display device 20. The information is divided into units in pages to be displayed on the display screen of the display device 20. The primary coil unit 13 acts as an interface for transmitting/receiving electric power and electronic information to/from the display devices 20, and generates magnetic flux from an electric current. Details of the structure of the primary coil unit 13 will be described later.

The secondary coil unit 21 is an interface for transmitting/receiving electric power and information to/from the instruction device 10. The secondary coil unit 21 includes plural spiral coils 211, 212, 213, . . . , 21n. Each of the spiral coils 211 to 21n is a planar coil which is formed by spiral winding of a lead wire. The spiral coils 211 to 21n each have a diameter of about 10 mm, and generate an electromotive force in accordance with a variation in magnetic flux, to thereby generate an electric current. In this case, the number “n” is an arbitrary natural number and can be appropriately set as required. In the present embodiment “n” is set as “7”.

The electric power extraction unit 22 extracts operation power for the display devices 20 from the electric current generated by the secondary coil unit 21, and supplies the extracted operation power to the display controller 24. The communication controller 23 has a determination circuit for determining which coil is presently generating an electric current among spiral coils 211 to 21n. The communication controller 23 transmits information indicating a determination result to the instruction device 10 via the secondary coil unit 21. If plural coils are generating electric currents, the determination circuit determines which coil is presently generating the greatest amount of electric current. The coil generating the greatest amount of electric current is determined to be closest to the top end of the instruction device 10. The communication controller 23 also receives display data via the secondary coil unit 21, and supplies the display data to the display controller 24. The communication controller 23 also transmits, to the secondary coil unit 21 via the secondary coil unit 21, information indicating a state of display processing in the display devices 20 or the like. The communication controller 23 is capable of receiving information other than display data and also of executing a processing according to a content of the information. The communication controller 23 has a memory for temporarily storing display data, or the like.

The display controller 24 has a drive circuit for driving the display 25 and controls a display on the display 25. The display controller 24 obtains display data from the communication controller 23 and supplies the display 25 with a drive voltage in accordance with the obtained display data. If desired, the display controller 24 can also be provided with a memory for prestoring display data.

The display 25 displays text and images on a predetermined display screen. The display screen of the display 25 is constituted of plural pixels which express a gradation tone corresponding to a supplied drive voltage. In this embodiment, each of the pixels constituting the display 25 has a liquid crystal layer in which memory liquid crystal is used. The term “memory liquid crystal” refers to a kind of liquid crystal that is capable of maintaining a display state (e.g., displayed gradation tones) without the need for continuously supplying an electric voltage. An example of such a memory liquid crystal is a cholesteric liquid crystal.

Complete structures of the instruction device 10 and display devices 20 have been described above. Next, there will be described details of respective components of the instruction device 10 and the display devices 20.

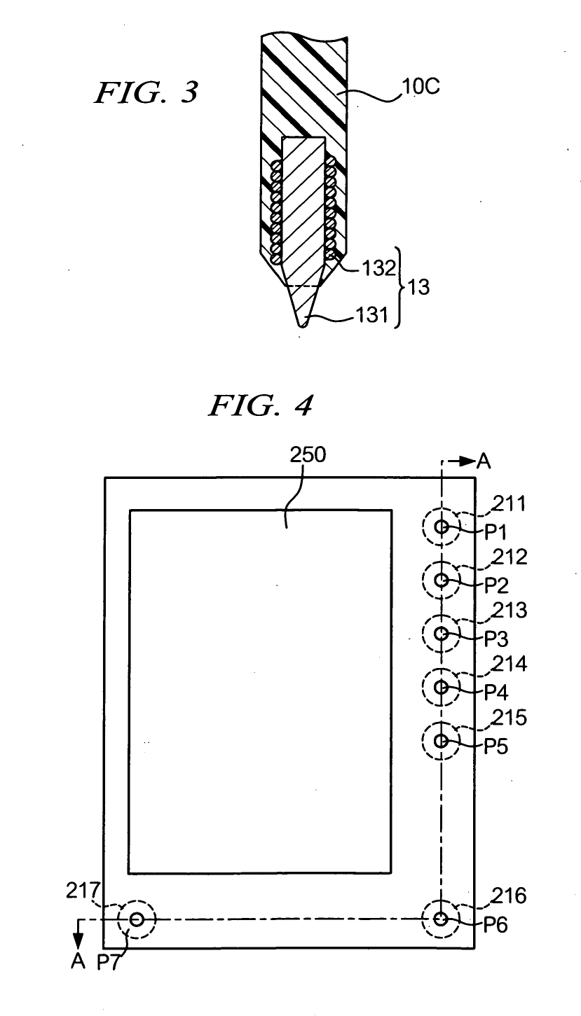

FIG. 3 is a cross-sectional view showing a structure of the primary coil unit 13 of the instruction device 10, the view being cut along a plane including the center axis of the instruction device 10. As shown in the figure, the primary coil unit 13 has a magnetic core 131 and an excitation coil 132.

The magnetic core 131 is a rod-like magnetic member which has high magnetic permeability in a frequency band used by the information display system 100. A top end part of the magnetic core 131 is exposed to the outside from a casing 10C of the instruction device 10. A part of the magnetic core 131 other than the top end part is covered by the casing 10C so as not to be exposed to the outside. Specifically, the magnetic core 131 has a part which is tapered, and a columnar part which has a uniform thickness (i.e., diameter). A thickness (i.e., diameter) of the tapered part decreases toward the top end of the magnetic core 131. The tapered part will be hereinafter referred to as the “top end part”, and the columnar part will hereinafter be referred to as a “shaft part”.

An exciting coil 132 is formed of a lead wire which is wound a predetermined number of turns around the shaft part of the magnetic core 131. When an electric current is generated, the exciting coil 132 causes a magnetic flux inside the coil to vary.

FIG. 4 shows a display screen of the display devices 20. As indicated in the figure, each of the display devices 20 has a display screen 250 and plural operation points P1, P2, P3, . . . , and P7. Predetermined operations are respectively assigned to the operation points P1 to P7. The operations assigned to the operation points P1 to P7 are, for example, performing page turning when display data is being displayed, along with various other settings and corresponding instructions. The operation points P1 to P7 are respectively associated with the spiral coils 211 to 217. For example, the operation point P1 is associated with the spiral coil 211, and the operation point P2 is associated with the spiral coil 212. That is, a number of operation points is equal to a number of spiral coils. At positions corresponding to the operation points P1 to P7 there is printed either text or images for indicating the corresponding points.

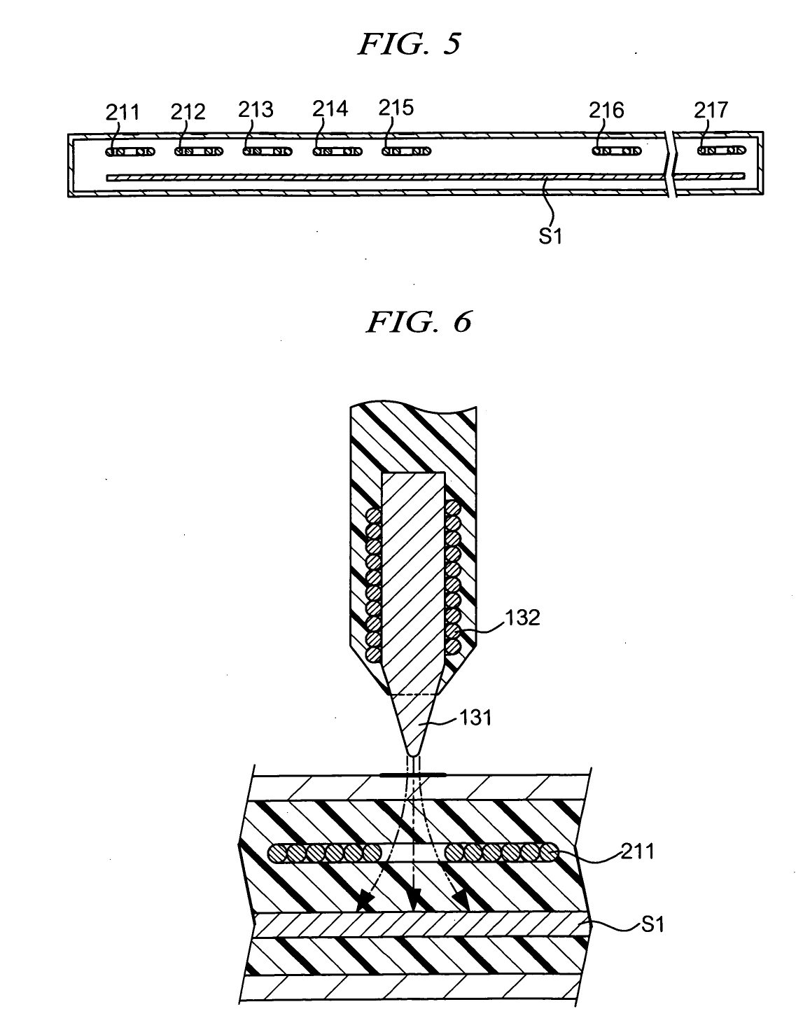

FIG. 5 is a cross-sectional view of the display device(s) 20 cut along a line A-A in FIG. 4. FIG. 5 shows the display screen side facing upwards. As shown in the figure, associated spiral coils 211 to 217 are respectively provided below the operation points P1 to P7. A magnetically highly-permeable layer S1 is provided below the spiral coils 211 to 217 so as to face the lower faces of the spiral coils 211 to 217. The magnetically highly-permeable layer S1 is formed of a sheet-like material containing a soft magnetic material as a raw material, although the layer S1 is merely an example of available magnetically highly-permeable members appropriate for use in the invention. It is possible to employ a thin film of a soft magnetic material, which has high magnetic permeability, such as Permalloy™, sendust, soft ferrite, or a resin formed by molding particles of the magnetic material descried above. The magnetically highly-permeable layer S1 needs to be provided at least below the spiral coils 211 to 217 but can also be provided so as to cover a broader area. For example, the magnetically highly-permeable layer S1 covers an area substantially equal to the upper face of the display device 20. The magnetically highly-permeable layer S1 can be constituted of plural small sheets which are respectively associated with the spiral coils 211 to 217.

In the structure described above, the information display system 100 displays text and images on the plural display devices 20. In the information display system 100, a user conducts operations by holding the casing 10C of the instruction device 10 in one hand and using the instruction device 10 as a writing tool such as a pen would be used. The operations can consist of, for example, actions of touching a center of the operation points P1 to P7 with the top end part of the instruction device 10. In this case, the top end part of the instruction device 10 is desirably brought into direct contact with the operation points P1 to P7 although the top end part can be spaced slightly apart from the points by a distance of up to several mm.

The top end part of the instruction device 10 and one or more of the spiral coils 211 to 217 are positioned to be closely proximate to each other at a predetermined distance. The closely proximate spiral coil and a primary coil unit 13 are electromagnetically coupled together. Electric power is thereby supplied to the display device 20, which performs a display operation on the display 25.

FIG. 6 schematically shows a coupling state between the primary coil unit 13 and the spiral coil 211. In the figure, two-dot chain lines indicate lines of magnetic force which extend toward the magnetically highly-permeable layer S1 from the magnetic core 131, as indicated by the arrows in the two-dot chain lines.

In the information display system 100 the configuration as described above is adopted, whereby adequate control of magnetic flux can be attained. In the information display system 100 according to the embodiment, the primary coil unit 13 of the instruction device 10 is provided with the top end part, and the display devices 20 are each provided with the magnetically highly-permeable layer S1. In this manner, a range within which a high level of electromagnetic coupling is activated can be restricted to a short distance and also to a small area. The information display system 100 according to the embodiment is therefore able to supply sufficient electric power and to specify which operation point is being indicated, even if the plural operation points P1 to P7 are positioned within a narrow range. According to experiments conducted by the present inventors, coupling between coils was activated (i.e., reacted strongly) only when the top end part of the magnetic core 131 was brought into close proximity within a range of about 5 mm from the center of each of the spiral coils 211 to 217. It was determined that electric power of about 100 mW was supplied from the instruction device 10 to the display device 20.

The display device 20 according to this embodiment adopts memory liquid crystal in the display screen so that electric power is required only when rewriting the display screen. The display device 20 operates in accordance with instructions from the instruction device 10. The display device 20 does not execute processing for turning pages or the like when no instruction is given from the instruction device 10. That is, the information display system 100 according to the embodiment is configured so that an amount of electric power is steadily and reliably supplied as required. As a result, each of the display devices 20 can perform the required rewriting operation and maintain a display state without the need for a storage battery or the like because required electric power can be supplied upon carrying out an operation.

The invention can be practiced not only in a form of the information display system 100 described above but also in other forms. For example, the above embodiment suggests an example in which client devices (e.g., display devices 20) are used for the purpose of display. However, the client devices can be used for other purposes. That is, any device can act as client devices in so far as the client devices execute processing by using electric power or electronic information supplied from a host device. In addition, the embodiment described above is configured so that one host device provides instructions to plural client devices. However, the configuration can be modified so that one host device serves only one client device.

The embodiment described above is also configured so as to provide a determination circuit for the communication controller 23. However, if it need not be determined which operation point is to be selected, the determination circuit can be omitted. For example, the determination circuit can also be omitted if only electric power is supplied from the instruction device 10.

In the embodiment described above, the display devices 20 are configured so as to depend on only the electric power supplied from the instruction device 10. However, the configuration can be modified so as to include a power supply such as a storage battery, and electric power can be supplied from both the instruction device 10 and the storage battery.

The embodiment described above uses memory liquid crystal for the display screen but a display medium other than memory liquid crystal can be used. An example of another display medium having memory capability is a micro-capsule electrophoretic type, e.g., a so-called EPD (Electrophoretic Display).

The spiral coils can be provided below the display screen. In this case, images are displayed on the display screen at positions corresponding to the spiral coils so as to constitute an operation means such as a touch panel. That is, in the display device configured in this manner, predetermined operations can be executed when the images displayed on the display screen are selected as operation points by the instruction device 10.

The configuration of the primary coil unit 13 can also be variously modified.

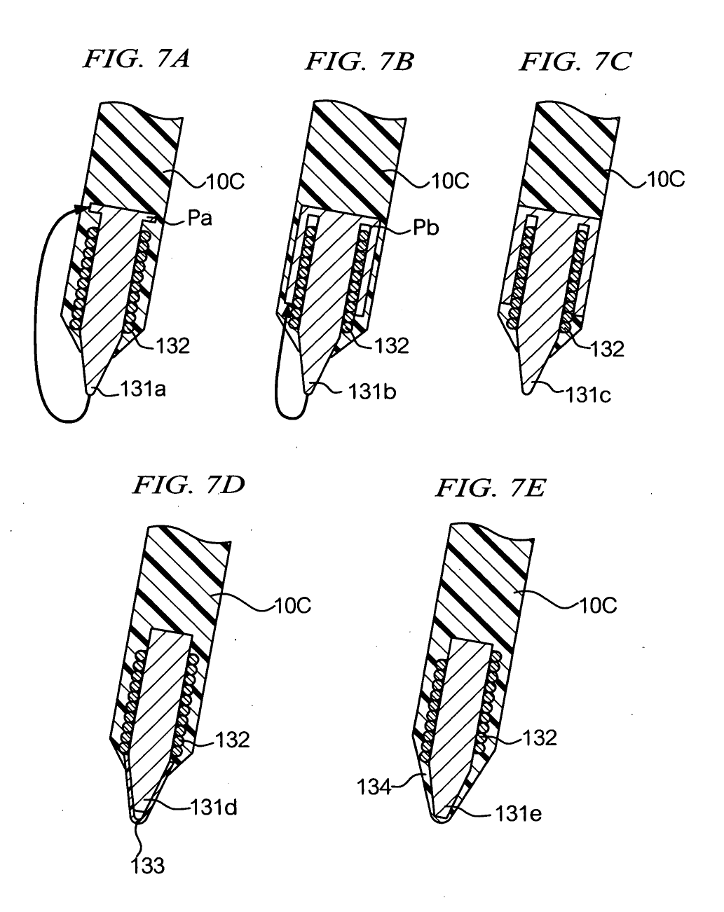

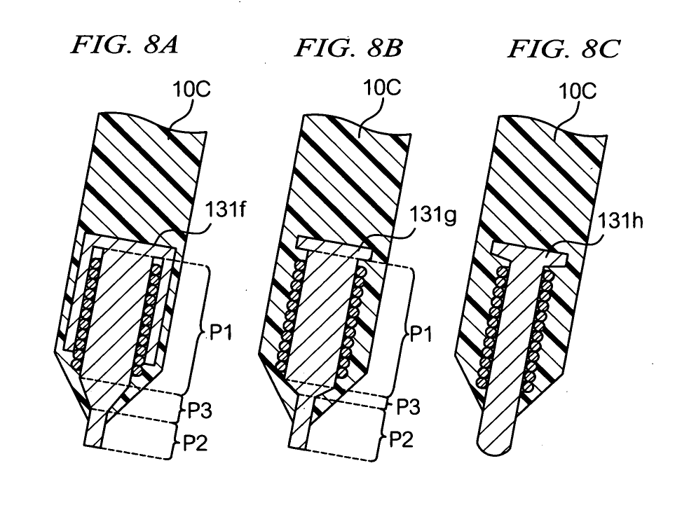

FIGS. 7 and 8 are cross-sectional views showing examples of shapes of the magnetic core and peripheral parts. The magnetic cores 131a and 131b shown in FIGS. 7A and 7B are each characterized by the shape of the end part (hereinafter “rear end part”) provided in an opposing relation to the top end part. The magnetic core 131a has a protruding part Pa protruding in a direction perpendicular to the center axis of the magnetic core. The magnetic core 131b has a protruding part Pb which protrudes in a direction perpendicular to the center axis of the magnetic core and has a collar folded back toward the top end part. In each of the magnetic cores 131a and 131b configured as described above, courses of magnetic lines of force extending from the top end part to the rear end part can be controlled so that more efficient coupling can be achieved. By controlling courses of magnetic lines of force, exposure of a user, who is holding the instruction device, to electromagnetic radiation can be minimized. The protruding parts can be exposed to the outside, for example, as in another magnetic core 131c shown in FIG. 7C.

The magnetic cores 131d and 131e shown in FIGS. 7D and 7E are characterized in that the cores are entirely covered so as not to be exposed to the outside. For example, another magnetic core 131d has a top end part covered with a coat member 133. The coat member is desirably formed of a relatively soft material such as plastic. Still another magnetic core 131e is entirely covered with a casing 134. In this configuration, the magnetic core can be prevented from becoming damaged when the magnetic core makes contact with operation points. This configuration is particularly suitable for use where the display screen is used as an operation interface such as a touch panel, as described previously.

Further, magnetic cores 131f and 131g shown in FIGS. 8A and 8B each have a first columnar part around which the exciting coil 132 is wound, and a second columnar part which is narrower than the first columnar part. Each of these magnetic cores has a conical tapered part between the first and second columnar parts. Also in the magnetic cores configured as described above, the top end to be brought into close proximity to the display device can be narrowed while the first columnar part is made thicker. If the part around which the exciting coil 132 is wound can have equal thickness to the top end, the tapered part can be omitted as in the case of another magnetic core 131h shown in FIG. 8C.

In the configurations shown in FIG. 8, the top end to be brought into close proximity to the display device is desirably round in form, from a viewpoint of protection of the display screen.

In brief, the magnetic core according to the invention is not specifically limited to any particular shape in so far as a required condition is satisfied. The required condition is that the magnetic core is configured so as to enable electromagnetic coupling with a coil to be excited owing to the generation of magnetic flux. Therefore, as long as such a condition is satisfied, the magnetic core according to the invention can be appropriately modified to have a shape desirable for holding by a user and/or to protect the display screen. In one incarnation it may be preferable that the end part of the magnetic core, at which the instruction device contacts with operation points or other object of the display device, is not wrapped by the exciting coil. Namely, controllability of the instruction device is improved when the end part of the device becomes thin due to omission of the exciting coil.

In the embodiment described above, the magnetically highly-permeable layer contains a magnetic material having high magnetic permeability and causes electromagnetic waves to attenuate due to magnetic permeable loss, which is included in the imaginary part of complex representation of the permeability of the material. At this time, energy of electromagnetic waves is converted into thermal energy. That is, the greater the effect of absorbing electromagnetic waves into the magnetically highly-permeable layer, the greater the thermal energy generated at the magnetically highly-permeable layer. In consideration of heat generated from the magnetically highly-permeable layer due to thermal energy, it is desirable that one magnetically highly-permeable layer is provided so as to face plural spiral coils.

Particularly taken into consideration is a case of applying the invention to a display device using an electronic non-volatile (image-retaining) display medium for the display screen, in which one single magnetically highly-permeable layer is desirably provided so as to face all of the plurality of spiral coils and to also face the entire area of the display screen. This is because in a case that image quality of an electronic non-volatile display medium is easily influenced by temperature, if a temperature difference were to occur in the display screen, a response speed or gradation level may readily deviate from a desired speed or level depending on an amount of temperature difference that exists.

If the magnetically highly-permeable layer is provided over two spiral coils, a temperature difference between areas respectively including the two spiral coils can be further reduced as compared to a case in which small pieces of magnetically highly-permeable layers are respectively provided for the two spiral coils. This is because thermal transfer is more highly promoted by providing one magnetically highly-permeable layer so as to cover as broad an area as possible. A configuration as described above is particularly effective in a case of providing spiral coils below the display screen, i.e., in a case of configuring a touch-panel-like operation means.

In the embodiment described of the invention, for example, materials which are commonly referred to as electromagnetic absorption sheets can be used as a magnetically highly-permeable material. Electromagnetic absorption sheets are classified as those having a function of pulling in magnetic lines of force, and those having a function of absorbing a part of electromagnetic waves. In the present embodiment, it is not necessary for a magnetically highly-permeable material to have the function of absorbing electromagnetic waves. This means that electro-conductivity of the material according to the present invention is not limited to any particular value.

What is claimed is:

1. An information processing system comprising:
a first device including
a magnetic core having a first end part to be brought into close proximity to the second device, and a second end part provided in opposing relation to the first end part,
an exciting coil wound around the magnetic core, and
a controller that causes the exciting coil to generate an electric current corresponding to at least one of electric power and electronic information; and
a second device including
a coil to be excited that generates an electric current in accordance with a variation in magnetic flux, and
a processing unit that executes processing by using, for the at least one of the electric power and electronic information, the electric current generated in the coil to be excited,
wherein
when the controller causes the exciting coil to generate an electric current, the coil to be excited is caused to generate the electric current in accordance with the variation of magnetic flux generated by the electric current generated in the exciting coil.

2. An information processing system according to claim 1, wherein:
the coil to be excited of the second device has a first face in a side in which the coil to be excited is brought into close proximity to the first end part of the magnetic core, and a second face facing the first face; and
a sheet-like magnetically highly-permeable member facing the second face of the coil to be excited.

3. An information processing system according to claim 2, wherein
the coil to be excited of the second device is provided in a plurality, and
the magnetically highly-permeable member facing the second face of each of the plurality of the coils to be excited.

4. The information processing system according to claim 1, wherein
the coil to be excited of the second device is provided in plurality, and
the second device further includes a determination unit that determines which of the plurality of coils to be excited is brought into close proximity to the first end part of the magnetic core.

5. The information processing system according to claim 1, wherein
the second device further includes an electronic non-volatile display that performs a display operation, and
the processing unit controls the display operation in the non-volatile display by using the at least one of the electric power and electronic information.

6. The information processing system according to claim 5, wherein, the second device further includes a sheet-like magnetically high-permeable member that overlaps a display screen of the electronic non-volatile display.

7. A supply device that supplies an external device with at least one of electric power and electronic information by electromagnetic coupling, the supply device comprising:
a magnetic core having a first end part in a side in which the external device is brought into close proximity to the supply device, and a second end part provided in opposing relation to the first end part;
an exciting coil wound around the magnetic core; and
a controller that causes the exciting coil to generate an electric current corresponding to the at least one of the electric power and electronic information.

8. The supply device according to claim 7, wherein a diameter of the magnetic core at the first end decreases toward a top end of the first end part.

9. The supply device according to claim 7, wherein the magnetic core has a protruding part at the second end part, the protruding part protruding in a direction perpendicular to a center axis of the magnetic core.

10. The supply device according to claim 7, wherein the magnetic core has a protruding part at the second end part, the protruding part protruding in a direction perpendicular to a center axis of the magnetic core and having a top end folded back toward the first end part.

11. The supply device according to claim 7, further comprising a cover that covers a part or all of the magnetic core and the exciting coil.
